(19) United States
(12) Patent Application Publication
(10) Pub. No.: US 2014/0133178 A1
(43) Pub. Date: May 15, 2014

(54) BACKLIGHT UNIT AND DISPLAY DEVICE HAVING THE SAME

(71) Applicant: SAMSUNG DISPLAY CO., LTD., Yongin-City (KR)

(72) Inventors: Yong-Hoon Kwon, Suwon-si (KR); Min-Young Song, Asan-si (KR); Byoung Dae Ye, Yongin-si (KR); Myung-Seok Kwon, Seongnam-si (KR); Seki Park, Asan-si (KR); Sangwon Lee, Seongnam-si (KR)

(73) Assignee: SAMSUNG DISPLAY CO., LTD., Yongin-City (KR)

(21) Appl. No.: 13/889,958

(22) Filed: May 8, 2013

(30) Foreign Application Priority Data
Nov. 9, 2012 (KR) 10-2012-0126879

(51) Int. Cl. F21V 8/00

(52) U.S. Cl. CPC G02B 6/0028
USPC 362/609; 362/608

(57) ABSTRACT

A display device includes a backlight unit generating light and a display panel displaying an image using the light from the backlight unit. The backlight unit includes a circuit board, a plurality of light emitting devices, a light guide member including a light incident surface, and a guide member disposed between a surface of the circuit board and the light incident surface. The guide member uniformly maintains a distance between the light incident surface and the light emitting devices. Thus, a light loss is reduced.

### CROSS-REFERENCE TO RELATED APPLICATION

This patent application claims priority under 35 U.S.C. §119 to Korean Patent Application No. 10-2012-0126879, filed on Nov. 9, 2012, the contents of which are hereby incorporated by reference in their entirety.

### TECHNICAL FIELD

The present disclosure relates to a backlight unit, and more particularly, to a backlight unit and a display device having the backlight unit.

### DISCUSSION OF THE RELATED ART

A display device may be classified as a transmissive type, a transflective type, or a reflective type. The transmissive and transflective type display devices include a display panel displaying an image and a separate backlight unit providing light to the display panel.

The backlight unit includes a light source emitting light and a light guide member guiding the light from the light source to the display panel. The light source includes a circuit board and a one or more light emitting devices mounted on the circuit board. The circuit board faces a light incident surface of the light guide member.

### SUMMARY

The present disclosure provides a backlight unit capable of uniformly providing light to a light guide member and reducing light loss.

The present disclosure provides a display device having the backlight unit.

Exemplary embodiments of the inventive concept provide a backlight unit including a light source, a light guide member, and a guide member. The light source includes a circuit board and a plurality of light emitting devices mounted on a surface of the circuit board. The light guide member includes a light incident surface facing the surface of the circuit board and guiding light from the light source. The guide member is disposed between the surface of the circuit board and the light incident surface and the guide member includes a plurality of holes arranged to respectively correspond to the light emitting devices.

The guide member includes a first surface making contact with the light incident surface, a second surface facing the first surface and making contact with the surface of the circuit board, and a plurality of connection surfaces that connect the first surface and the second surface. The holes are formed penetrating through the first and second surfaces.

The holes are formed by removing portions of the guide member having a truncated cone shape or a polygonal cone shape.

Each of the holes includes a wall surface inclined with respect to the first and second surfaces. The wall surface forms an acute angle with respect to the second surface.

The guide member includes an elastic polymer or silicon and the guide member has a white color.

The circuit board includes a plurality of lines and a plurality of connection pads respectively connected to the lines, the connection pads exposed to the exterior, and each of the light emitting devices includes a light emitting diode electrically connected to a corresponding connection pad of the connection pads.

Each of the light emitting devices further includes a sealant member protecting the light emitting diode. The sealant member makes contact with the surface of the circuit board.

Exemplary embodiments of the inventive concept provide a display device including the above-mentioned backlight unit and a display panel that displays an image using the light provided from the backlight unit.

The display device further includes a protective member that accommodates the backlight unit and a support member coupled to the protective member holding the circuit board. The protective member includes a first bottom portion and a first sidewall portion bent from the first bottom portion. The support member includes a second bottom portion disposed on the first bottom portion and a second sidewall portion bent from the second bottom portion. The other surface of the circuit board, which faces the surface of the circuit board, is disposed on the second sidewall portion.

According to the above, the light generated by the light emitting devices is guided to the light incident surface of the light guide member by the guide member. The wall surfaces of the holes of the guide member reflect the light from the light emitting devices and the reflected light travels to the light incident surface of the light guide member. Thus, the amount of the light incident into the light guide member is increased and the light loss is reduced.

The guide member uniformly maintains the distance between the surface of the circuit board and the light incident surface of the light guide member. The distances between the light incident surface and the light emitting devices are substantially identical. Therefore, the light is uniformly provided to the light guide member over all areas of the light guide member.

The guide member formed of the elastic material absorbs shock from external impacts. Accordingly, although the guide member makes contact with the light incident surface, the light incident surface may be prevented from being damaged due to impact.

The light guide member uniformly provides light to the display panel over all areas of the display panel. Therefore, the display panel displays the image with uniform brightness.

### BRIEF DESCRIPTION OF THE DRAWINGS

The above and other aspects of the present disclosure will become readily apparent by reference to the following detailed description when considered in conjunction with the accompanying drawings wherein:

FIG. 1 is an exploded perspective view showing a display device according to an exemplary embodiment of the present disclosure;

FIG. 2 is an exploded perspective view showing a part of the display device shown in FIG. 1;

FIG. 3 is an enlarged view showing a part of a light source shown in FIG. 1;

FIG. 4 is an exploded perspective view showing a light source and a guide member shown in FIG. 1;

FIG. 5 is a coupled perspective view showing the light source and the guide member shown in FIG. 1;

FIG. 6 is a cross-sectional view taken along a line I-I′ of FIG. 5;

FIG. 7 is a view showing a function of the guide member shown in FIG. 5; and

FIG. 8 is a plan view showing a coupled state of parts shown in FIG. 1.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. Like numbers may refer to like elements throughout the instant disclosure.

Hereinafter, exemplary embodiments of the present invention will be explained in detail with reference to the accompanying drawings.

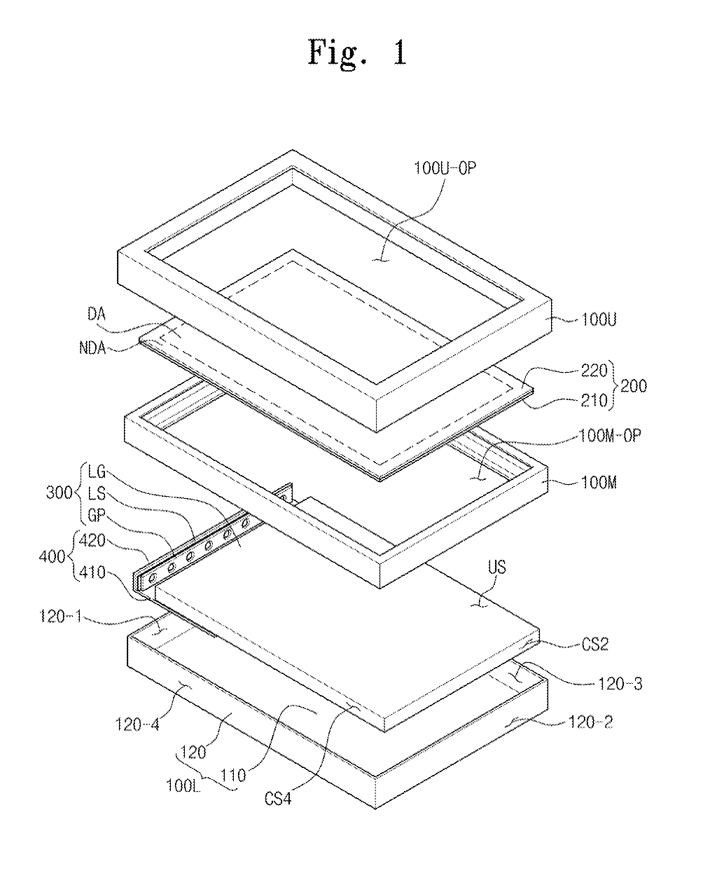

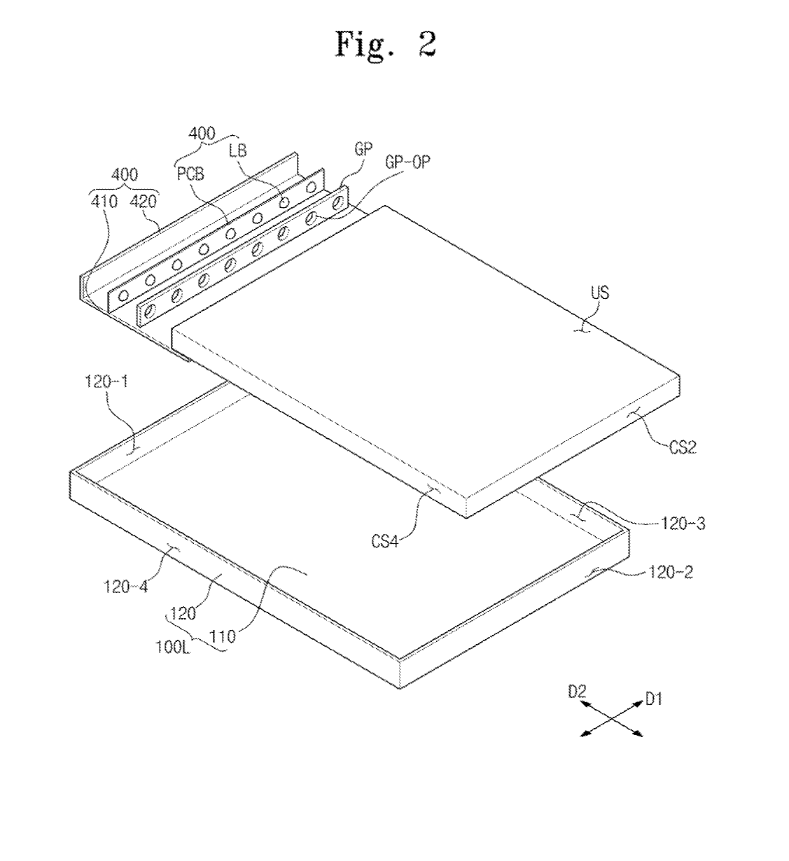

FIG. 1 is an exploded perspective view showing a display device according to an exemplary embodiment of the present disclosure and FIG. 2 is an exploded perspective view showing a part of the display device shown in FIG. 1.

Referring to FIGS. 1 and 2, the display device includes protective members 100U and 100L, a display panel 200, and a backlight unit 300.

The protective members 100U and 100L include an upper protective member 100U and a lower protective member 100L, which are coupled with each other. The upper and lower protective members 100U and 100L serve as outer portions of the display device and accommodate other elements of the display device.

The upper protective member 100U is disposed on the display panel 200. The upper protective member 100U includes an opening portion 100U-OP formed therethrough exposing a portion of the display panel 200, e.g., a display area DA in which an image is displayed. The upper protective member 100U is disposed overlapping with a non-display area NDA of the display panel 200. The non-display area NDA is disposed adjacent to the display area DA and the image is not displayed in the non-display area NDA.

The lower protective member 100L is disposed under the display panel 200. The lower protective member 100L includes a bottom portion 110 (hereinafter, referred to as a first bottom portion) and a sidewall portion 120 (hereinafter, referred to as a first sidewall portion) bent upward from the first bottom portion 110.

For example, the first bottom portion 110 may have a rectangular shape. The first sidewall portion 120 is bent from four sides of the first bottom portion 110. The first sidewall portion 120 is divided into four parts 120-1 to 120-4 respectively corresponding to the four sides of the first bottom portion 110.

The display device further includes an intermediate protective member 100M. The intermediate protective member 100M is disposed between the upper protective member 100U and the lower protective member 100L. The intermediate protective member 100M may have, but is not limited to having, a rectangular frame shape overlapping the non-display area NDA of the display panel 200. The intermediate protective member 100M includes an opening portion 100M-OP formed therethrough. The intermediate protective member 100M supports the display panel 200.

The display panel 200 receives light from the backlight unit 300 and displays the image. The display panel 200 is a transmissive type or a transflective type display panel. For example, the display panel 200 may be a liquid crystal display panel, an electrophoretic display panel, or an electrowetting display panel. The liquid crystal display panel that includes a first substrate 210, a second substrate 220, and a liquid crystal layer (not shown) disposed between the first substrate 210 and the second substrate 220 will be described as the display panel 200.

The backlight unit 300 includes a light source LS emitting light, a light guide member LG guiding the light from the light source LS to the display panel 200, and a guide member GP disposed between the light source LS and the light guide member LG

The light source LS includes a circuit board PCB and a plurality of light emitting devices LB mounted on the circuit board PCB.

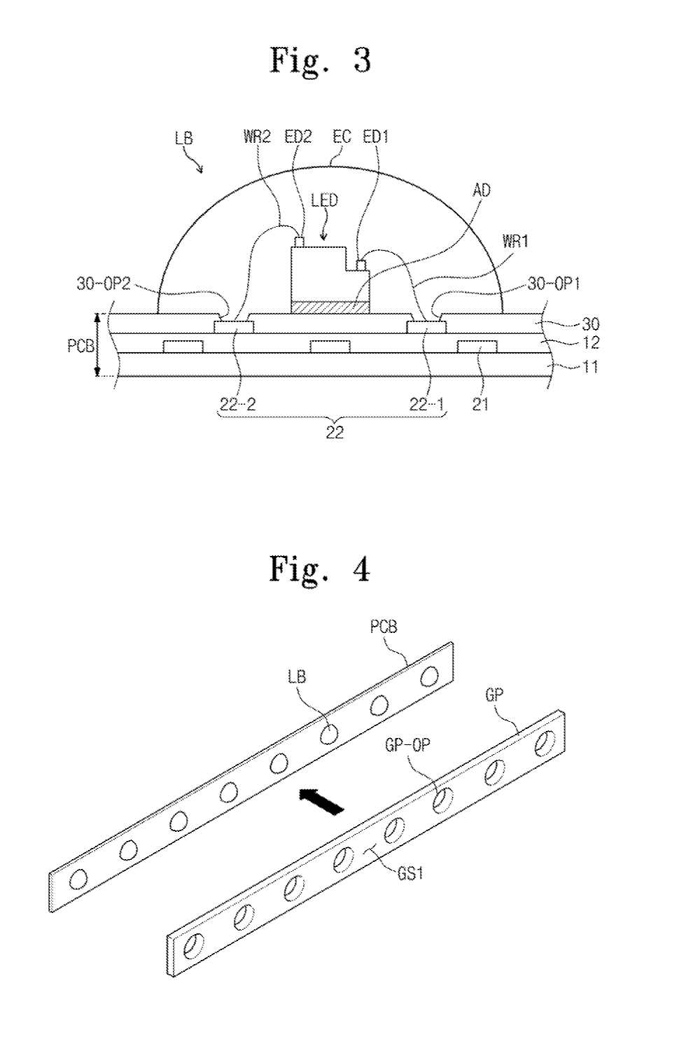

FIG. 3 is an enlarged view showing a part of a light source shown in FIG. 1. FIG. 3 shows one light emitting device LB and a cross section of the circuit board PCB corresponding to the light emitting device LB.

Referring to FIG. 3, the circuit board PCB includes at least one insulating layer and at least one circuit layer. FIG. 3 shows a multi-layer circuit board configured to include two insulating layers 11 and 12 and two circuit layers 21 and 22, which are alternately stacked.

Among the two circuit layers 21 and 22, the circuit layer 22 disposed at uppermost position is covered by a protective layer 30. The uppermost-positioned circuit layer 22 includes a plurality of lines (not shown) and connection pads 22-1 and 22-2 connected to the lines (not shown). The protective layer 30 includes openings 30-OP1 and 30-OP2 formed therethrough to respectively expose the connection pads 22-1 and 22-2.

The light emitting device LB is mounted on a surface of the circuit board PCB. As shown in FIG. 3, the light emitting device LB includes a light emitting diode LED. The light emitting diode LED generates light in response to a driving voltage applied thereto through a first electrode ED1 and a second electrode ED2. The light emitting diode LED has a structure in which an n-type semiconductor layer, an active layer, and a p-type semiconductor are sequentially stacked one on another. When the driving voltage is applied to the light emitting diode LED, electrons are combined with holes and light is generated by the combination between the electrons and the holes.

The first electrode ED1 is connected to one of the connection pads 22-1 and 22-2 and the second electrode ED2 is connected to the other one of the connection pads 22-1 and 22-2. The first and second electrodes ED1 and ED2 are respectively connected to the connection pads 22-1 and 22-2 by wirings WR1 and WR2. The light emitting diode LED may be attached to the protective layer 30 by an adhesive member AD.

In addition, the light emitting device LB further includes a sealant member EC protecting the light emitting diode LED. The sealant member EC prevents the wirings WR1 and WR2 from being disconnected or oxidized. The sealant member EC is formed of a resin material, e.g., an epoxy resin, and includes one or more scattering agents distributed therein.

The sealant member EC has a hemispherical shape to allow a portion thereof to make contact with the surface of the circuit board PCB. The sealant member EC having the hemispherical shape is formed by spotting sealant onto the circuit board PCB and curing the sealant.

Referring to FIGS. 1 and 2 again, the light guide member LG is disposed under the display panel 200. The light guide member LG includes a first surface US, a second surface (not shown), and a plurality of connection surfaces to connect the first surface US and the second surface. The light guide member LG has a rectangular plate shape. The connection surfaces include two connection surfaces facing each other in a first direction D1 and two connection surfaces facing each other in a second direction D2. The first direction D1 and the second direction D2 are substantially perpendicular to each other. FIGS. 1 and 2 show two connection surfaces CS2 and CS4 among the connection surfaces.

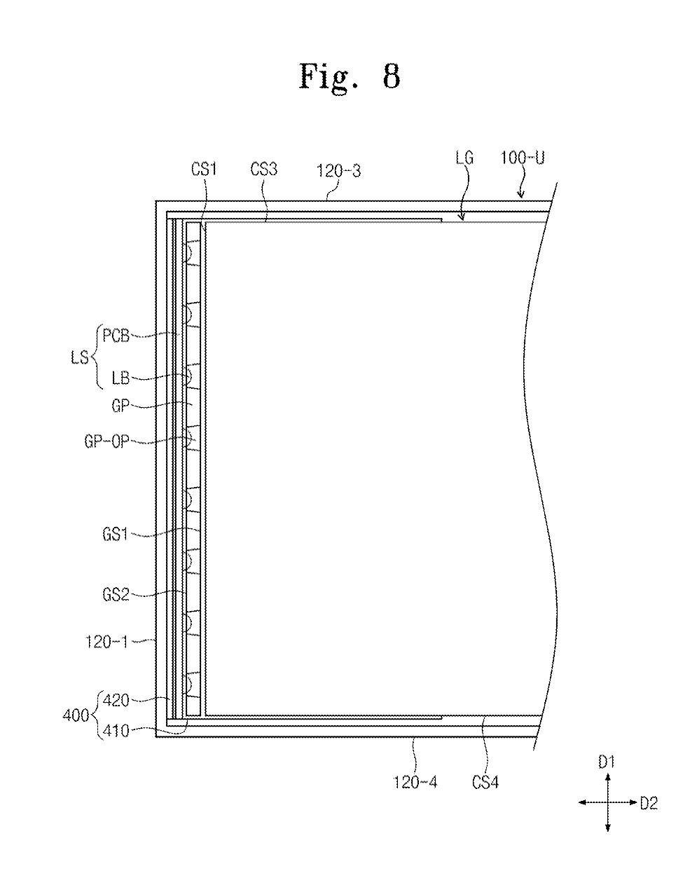

One connection surface of the two connection surfaces facing each other in the second direction D2 faces the light emitting devices LB. The connection surface facing the light emitting devices LB is referred to as a light incident surface CS1 (refer to FIG. 8). The light incident surface CS1 faces the connection surface CS2 (hereinafter, referred to a light opposite surface) shown in FIGS. 1 and 2.

According to an exemplary embodiment, the two connection surfaces facing each other in the first direction D1 are referred to as a first side surface CS3 (refer to FIG. 8) and a second side surface CS4, respectively. The first and second side surfaces CS1 and CS4 connect the light incident surface CS1 and the light opposite surface CS2. The light incident surface CS1 and the light opposite surface CS2 are extended in the first direction D1 and the first and second side surfaces CS3 and CS4 are extended in the second direction D2.

The light incident into the light guide member LG through the light incident surface CS1 exits through the first surface US. The second surface (not shown) faces the first surface US in a thickness direction of the light guide member LG.

The guide member GP is disposed between the circuit board PCB and the light incident surface CS1. The guide member GP includes a plurality of holes GP-OP arranged to correspond to the light emitting devices LB, respectively.

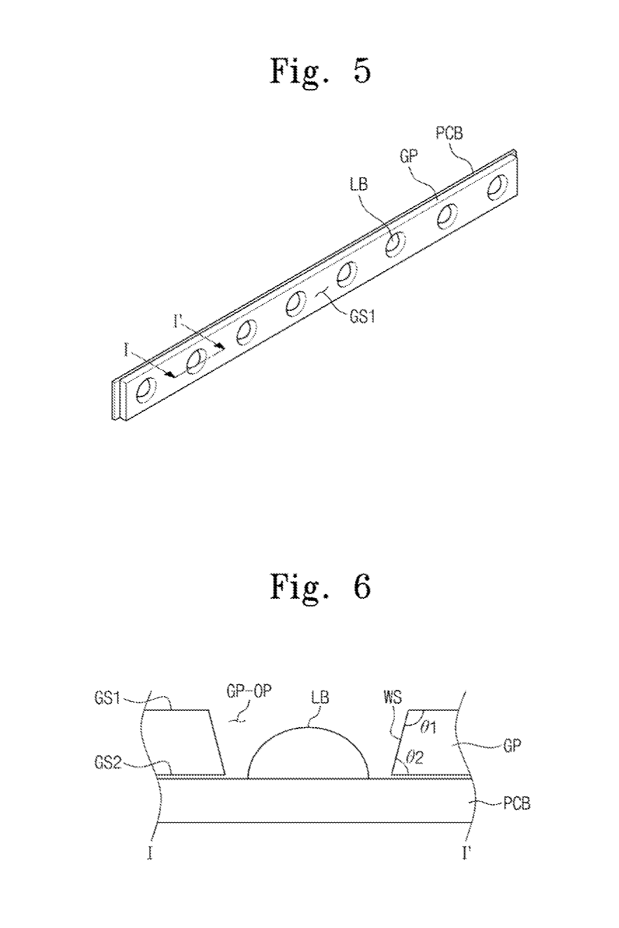

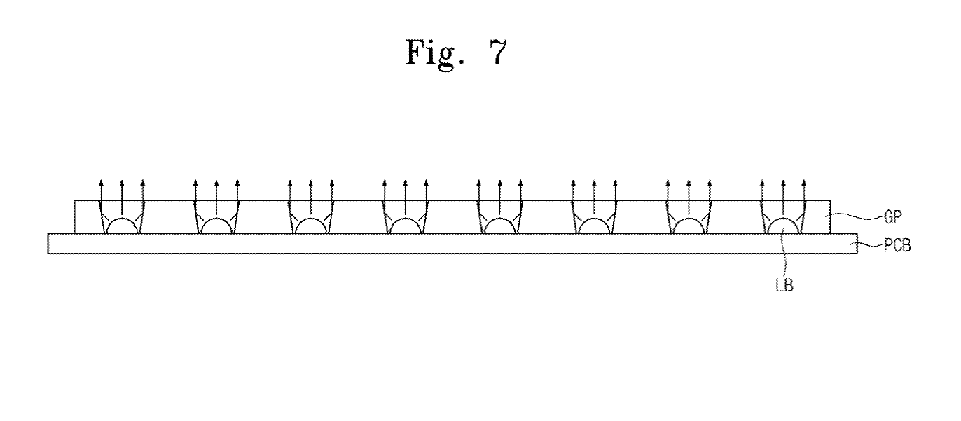

FIG. 4 is an exploded perspective view showing the light source and the guide member shown in FIG. 1 and FIG. 5 is a coupled perspective view showing the light source and the guide member shown in FIG. 1. FIG. 6 is a cross-sectional view taken along a line I-I′ of FIG. 5 and FIG. 7 is a view showing a function of the guide member shown in FIG. 5. Hereinafter, the guide member GP will be described in detail with reference to FIGS. 4 to 7.

The guide member GP is extended in the first direction D1 as the circuit board PCB. The holes GP-OP are formed by removing portions of the guide member GP of a truncated cone shape or a polygonal cone shape.

As used herein, a truncated cone shape is a conic cross-section having a circular top surface and a circular bottom surface that is larger than or smaller than the circular top surface. As used herein, a polygonal cone shape is similar to a truncated cone shape but has a polygon top surface and a polygon bottom surface that is larger than or smaller than the polygon top surface. The polygonal cone shape may also be considered a truncated pyramid.

The guide member GP includes a first surface GS1 making contact with the light incident surface CS1 and a second surface GS2 (refer to FIG. 6) facing the light incident surface CS1 and making contact with the surface of the circuit board PCB. In addition, the guide member GP includes a plurality of connection surfaces to connect the first surface GS1 and the second surface GS2.

The holes GP-OP are formed penetrating through the first surface GS1 and the second surface GS2. Each of the holes GP-OP is defined by a wall surface WS (refer to FIG. 6) inclined with respect to the first and second surfaces GS1 and GS2. The wall surface WS forms an obtuse angle θ1 with the first surface GS1 and forms an acute angle θ2 with the second surface GS2.

According to an exemplary embodiment, the holes GP-OP are formed by removing portions of the guide member GP in a cylindrical shape or a polygonal prism shape. In this case, the wall surface WS forms a right angle with the first and second surfaces GS1 and GS2.

Referring to FIG. 7, a portion of the light generated from the light emitting devices LB directly travels to the light incident surface CS1 and the other portion of the light travels to the wall surface WS. A portion of the light provided to the wall surface WS is reflected by the wall surface WS, and then travels to the light incident surface CS1. The guide GP guides most of the light generated by the light emitting devices LB to the light incident surface CS1. Accordingly, the amount of light traveling to the light incident surface CS1 is increased and thus the light loss is reduced. According to an exemplary embodiment, to enhance reflectivity of the wall surface WS, the guide GP has a white color. In other exemplary embodiment, the guide GP further includes a reflective layer on the wall surface WS. The reflective layer comprise the reflective materials e.g. metal. The reflective layer may be a reflective coating layer or a reflecting tape. The reflective layer is formed by coating or deposition or lamination. In other exemplary, the guide GP comprises a reflective material.

Referring to FIGS. 1 and 2 again, the display device further includes a support member 400. The support member 400 is coupled to the lower protective member 100L to hold the circuit board PCB. The support member 400 includes a bottom portion 410 (hereinafter, referred to as a second bottom portion) and a sidewall portion 420 (hereinafter, referred to as a second sidewall portion) bent from the second bottom portion 410.

The second bottom portion 410 is disposed on the first bottom portion 110 to support a portion of the light guide member LG. The support member 400 may be fixed to the first bottom portion 110. For example, the second bottom portion 410 may be fixed to the first bottom portion 110 by a fixing member, e.g., a screw. The second sidewall portion 420 faces a portion 120-1 of the first sidewall portion 120.

FIG. 8 is a plan view showing a coupled state of the parts shown in FIG. 1. In FIG. 8, the parts are spaced apart from each other to show boundaries between the parts, but the parts may make contact with each other.

Referring to FIG. 8, the second sidewall portion 420 makes contact with the portion 120-1 of the first sidewall portion 120. The circuit board PCB makes contact with the second sidewall portion 420. The guide member GP is disposed between the surface of the circuit board PCB and the light incident surface CS1 of the light guide member LG The light emitting devices LB are inserted into the holes GP-OP, respectively.

The first surface GS1 of the guide member GP makes contact with the light incident surface CS1 and the second surface GS2 of the guide member GP makes contact with the surface of the circuit board PCB. The light incident surface CS1 and the circuit board PCB are spaced apart from each other by the thickness of the guide member GP. A distance between a peak of the light emitting devices LG and the light incident surface CS1 is uniformly maintained by the guide member GP. The peak of the light emitting devices LB may correspond to one position of the sealant member EC (refer to FIG. 3), which is most close to the light incident surface CS1.

An outer surface of the second sidewall portion 420 makes contact with an inner surface of the first sidewall portion 120. The circuit board PCB makes contact with an inner surface of the second sidewall portion 420. The guide member GP makes contact with the light incident surface CS1 and the surface of the circuit board PCB. A distance between the light incident surface CS1 and each of the light emitting devices LB is uniformly maintained by the guide member GP. For example, distances between the light incident surface CS1 and the light emitting devices LB are the same. Thus, the light is uniformly supplied to the light guide member LG over all areas of the light guide member LG.

The guide member GP includes an elastic material. For example, the guide member GP may be formed of an elastic polymer or silicon. The guide member GP absorbs shock from external impacts. Accordingly, the light incident surface CS1 may be prevented from being damaged due to friction between the guide member GP and the light incident surface CS1.

Although not shown in figures, the display device may further include an optical sheet and a reflective sheet increasing light efficiency of the light provided to the display panel 200.

The optical sheet is disposed between the light guide member LG and the display panel 200. The optical sheet includes a prism sheet disposed on the light guide member LG The prism sheet condenses the light exiting from the first surface US of the light guide member LG allowing the light to travel in a direction substantially vertical to the display panel 200. The light exiting from the prism sheet is vertically incident into the display panel 200.

In addition, the optical sheet further includes a diffusion sheet diffusing the light exiting from the first surface US of the light guide member LG. The diffusion sheet is disposed between the light guide member LG and the prism sheet.

The reflective sheet is disposed under the light guide member LG. The reflective sheet reflects the light leaked through the second surface (not shown) of the light guide member LG allowing the leaked light to travel to the light guide member LG.

Although exemplary embodiments of the present invention have been described, it is understood that the present invention should not be limited to these exemplary embodiments but various changes and modifications can be made by one ordinary skilled in the art within the spirit and scope of the present invention.

What is claimed is:

1. A backlight unit comprising:
a light source including a circuit board and a plurality of light emitting devices mounted on a front surface of the circuit board;
a light guide member including a light incident surface facing the front surface of the circuit board, the light guide member guiding light from the light source; and
a guide member disposed between the front surface of the circuit board and the light incident surface of the light guide member and including a plurality of holes that correspond to the plurality of light emitting devices.

2. The backlight unit of claim 1, wherein the guide member comprises:
a first surface facing the light incident surface of the light guide member;
a second surface facing the first surface and making contact with the front surface of the circuit board; and
a plurality of connection surfaces that connects the first surface and the second surface, wherein each of the plurality of holes penetrate through the first and second surfaces.

3. The backlight unit of claim 2, wherein the first surface is contact with the light incident surface of the light guide member.

4. The backlight unit of claim 2, wherein each of the plurality of holes extends through the guide member and has a truncated cone shape or a polygonal cone shape.

5. The backlight unit of claim 2, wherein each of the plurality of holes comprises a wall surface inclined with respect to the first and second surfaces, wherein the wall surface forms an acute angle with the second surface.

6. The backlight unit of claim 5, wherein each depth of the plurality of holes is equal to or larger than each height of the correspond plurality of light emitting devices.

7. The backlight unit of claim 5, wherein the wall surface of each of the holes reflects the light from the light emitting.

8. The backlight unit of claim 7, the reflected light from the wall surface travels to the light incident surface of the light guide member.

9. The backlight unit of claim 2, wherein the guide member comprises an elastic polymer or silicon.

10. The backlight unit of claim 9, wherein the guide member has a white color.

11. The backlight unit of claim 1, wherein the circuit board comprises a plurality of lines and a plurality of connection pads respectively connected to the lines, wherein the connection pads are exposed to exterior, and each of the plurality of light emitting devices comprises a light emitting diode electrically connected to a corresponding connection pad of the plurality of connection pads.

12. The backlight unit of claim 11, wherein each of the plurality of light emitting devices further comprises a sealant member protecting the light emitting diode, wherein the sealant member makes contact with the front surface of the circuit board.

13. A display device comprising:
a backlight unit generating light; and
a display panel displaying an image using the light provided from the backlight unit, the backlight unit comprising:
a light source including a circuit board and a plurality of light emitting devices mounted on a front surface of the circuit board;
a light guide member including a light incident surface facing the front surface of the circuit board, and the light guide member guiding the light from the light source to the display panel; and
a guide member disposed between the front surface of the circuit board and the light incident surface of the light guide member and including a plurality of holes that correspond to the plurality of light emitting devices.

14. The display device of claim 13, wherein the guide member comprises:
a first surface facing the light incident surface of the light guide member;
a second surface facing the first surface and making contact with the front surface of the circuit board; and
a plurality of connection surfaces that connects the first surface and the second surface, wherein each of the plurality of holes penetrate through the first and second surfaces.

15. The backlight unit of claim 14, wherein the first surface is contact with the light incident surface of the light guide member.

16. The display device of claim 14, wherein each of the plurality of holes extends though the guide member and has a truncated cone shape or a polygonal cone shape.

17. The display device of claim 14, wherein each of the plurality of holes comprises a wall surface inclined with respect to the first and second surfaces, wherein the wall surface forms an acute angle with the second surface.

18. The backlight unit of claim 17, wherein each depth of the plurality of holes is equal to or larger than each height of the correspond plurality of light emitting devices.

19. The backlight unit of claim 17, wherein the wall surface of each of the holes reflects the light from the light emitting.

20. The backlight unit of claim 19, the reflected light from the wall surface travels to the light incident surface of the light guide member.
